(19) United States
(12) Patent Application Publication
(10) Pub. No.: US 2021/0304646 A1
(43) Pub. Date: Sep. 30, 2021

(54) FLAG COMPRISING A BUILT-IN DEVICE

(71) Applicant: DISPLAY LIGHT, Montauban (FR)

(72) Inventor: Didier Azorin, Montauban (FR)

(73) Assignee: DISPLAY LIGHT, Montauban (FR)

(21) Appl. No.: 17/266,081

(22) PCT Filed: Jul. 26, 2019
(86) PCT No.: PCT/EP2019/070245

§ 371 Date: Feb. 4, 2021

(30) Foreign Application Priority Data
Aug. 9, 2018 (FR) 1857402

(51) Int. Cl. G09F 17/00; G09F 9/30; G09F 27/00

(52) U.S. Cl. CPC G09F 17/00; G09F 27/007; G09F 9/30

(57) ABSTRACT

The invention relates to a flag comprising a piece of material suitable for mounting on a mast and having at least two faces. The piece of material comprises at least one pocket which is formed between said two faces and is suitable for receiving an electrical or electronic device. At least one of the faces of the piece of material comprises at least one opening located on said at least one pocket in such a way as to allow the passage of the light emitted by said device or towards said device.

### TECHNICAL FIELD

The present invention relates to the field of signage and relates more particularly to a flag made of material with a lighted panel. The invention aims in particular to allow for the use of a signage element made of material comprising a lighted panel on a mast, in particular a vertical or horizontal mast.

### BACKGROUND

In the field of signage, it is known to use different types of supports. It is in particular known to use flags, for example so-called “wall” flags and pennants. In a known way, a flag has the form of a piece of fabric, in particular made of material, mounted on a shaft or on a mast. A wall flag is mounted on a mast fixed on a wall, for example horizontally or obliquely, and a pennant (also called advertising sail) is fixed on a mast, for example vertical, which is either fixed in the ground, or mounted on a leg placed on the ground so as to be able to be moved and be positioned indoors as well as outdoors.

These types of flags are in particular used for advertising purposes in order to promote a brand or illustrate an advertisement in the form of text or a drawing. In a known way, the marks (letters, drawings, etc.) representing the brand or the advertisement are printed directly on the material, for example on the two faces of the flag.

However, once the marks are printed on the material, it is no longer possible to erase them in order to replace them, which leads to having to use a new piece of material to manufacture a flag with different marks. In addition, these flags have the major disadvantage of now being visible in low light or in the absence of light. Also, when it is necessary to make them visible at night or in low light, it is known to illuminate them, in particular with spotlights or neon tubes, which can be complex, expensive and even ineffective, particularly in the case of wind.

To overcome the latter disadvantage, it is also known to use wall signs or terminals comprising a frame closed by two translucent panels between which are mounted neon tubes or light bulbs. However, this type of support can be particularly expensive, heavy and relatively fragile. In addition, when it is necessary to replace the marks engraved or printed on the panels, the panels or the sign itself has to be changed, which can be complex and particularly expensive.

There is therefore a need for a simple, reliable, effective and inexpensive solution that makes it possible to overcome the aforementioned disadvantages at least partially.

### SUMMARY

To this effect, the invention first of all has for object a flag, in particular for advertising purposes, comprising a piece of material suitable for mounting on a mast and comprising at least to faces, said flag being remarkable in that said piece of material comprises at least one pocket, formed between said two faces and is suitable for receiving an electrical or electronic device, and in that at least one of the faces of the piece of material comprises at least one opening located on said at least one pocket, in such a way in particular as to allow the passage of the light emitted by said device (for example when the latter is a lighting panel) or towards said device (for example when the latter is a solar panel) or to make said device visible (for example when the latter is a screen or display panel).

The flag according to the invention makes it possible to insert an electrical or electronic device in the pocket so as to fulfil different functions. Using a flag according to the invention makes it possible in particular to avoid the use of plastic panels, which can be less expensive and more ecological. In addition, using a part made of material makes the flag light which can thus be transported very easily. The flag may for example be a pennant, a wall flag or even a sunshade canvas. The at least one pocket is preferably formed between two thicknesses but may be formed between more than two thicknesses.

Preferably, the piece of material comprises two faces opposite one another.

In an embodiment, said two faces each comprise at least one opening located at the at least one pocket.

Alternatively, the piece of material may comprise more than two faces, for example three or four.

According to an aspect of the invention, the material is a sunshade canvas, made for example from acrylic and/or polyester.

Preferably, the flag comprises at least one electrical or electronic device inserted into the at least one pocket. The device may in particular be a lighted panel or a solar panel.

In this case, according to an aspect of the invention, the at least one pocket has dimensions substantially identical to the dimensions of the electrical or electronic device so as to firmly hold it in said at least one pocket while still protecting it from the exterior.

In this case, advantageously, the at least one pocket may be closed definitively, for example using a seam so as to effectively hold the electrical or electronic device in the pocket while still preventing a third party from accessing the electrical or electronic device. Alternatively, the at least one pocket may be closed temporarily, in particular using a self-gripping strip, for example of the Velcro® type in order to effectively hold the electrical or electronic device in the pocket while still allowing the maintenance or the exchanging thereof.

According to an aspect of the invention, the lighted panel is a lighting panel or a display panel. The lighting panel may be an electroluminescent panel, for example a LED lighting panel or any other suitable technology. The display panel may be a panel of the LCD, electroluminescent, OLED®, QLED®, plasma type or any other suitable technology. The display panel may be connected to a communication network so as to control the display thereof remotely.

In an embodiment, the lighting panel comprising two faces, at least one of the faces of the panel comprises at least one mark that is visible through the at least one corresponding opening, in particular at least one letter or at least one logo, for example applied by screen printing.

Advantageously, the at least one opening delimits at least one letter or at least one logo.

Further advantageously, the at least one opening is of rectangular or square shape.

In an embodiment, the device is a solar panel. Such a solar panel may in particular be used so as to recharge at least one power supply battery mounted in the flag or to provide current to an external entity, for example a piece of electrical equipment, for example an external battery, or an electrical network.

In an embodiment, the flag comprising a plurality of pockets, each pocket comprises a device from among a lighting panel and/or a display panel and/or a solar panel and/or an electrical energy storage battery.

Advantageously, the flag comprises a communication module able to communicate with a control device, in particular over a wireless communication link, so as to control the device or devices, for example the turning on and the turning off of a lighted panel, the display of a display panel, monitor the production of electricity of the solar panel, etc.

The invention also relates to an assembly comprising a support structure and a flag, such as presented hereinabove, mounted on said support structure.

Preferably, the support structure comprises a mast. Such a mast may in particular have the shape of a shaft, a rod or any suitable support. The mast may be in particular configured to be fixed vertically, obliquely or horizontally.

Advantageously, the assembly further comprises at least one electrical energy storage battery allowing for the power supply of the device or devices, in particular when said device or devices comprise a lighting panel or a display panel, and/or making it possible to be recharged by the device or devices, for example when said device or devices comprise one or more solar panels.

The battery may comprise several electrical energy storage modules, connected in series or in parallel.

The battery may be mounted on the support structure or in a pocket formed in the piece of material.

Alternatively or as a supplement, the assembly may be adapted to be connected to an electrical network, for example via a voltage transformer.

In an embodiment, the assembly comprises a leg configured to rest on the ground and whereon the mast is mounted.

In the case where the flag is a sunshade canvas, the support structure comprises a central mast and ribs on which the central portion of said canvas is mounted the periphery of which is free and comprises one or more pockets configured to receive an electrical or electronic device.

### DESCRIPTION OF DRAWINGS

The invention will be better understood when reading the following description, given solely as an example, and in reference to the accompanying drawings given as non-limiting examples, wherein identical references are given to similar objects and wherein:

FIG. 1 diagrammatically shows a first embodiment of an assembly comprising a flag according to the invention,

FIG. 2 shows the support structure of the assembly of FIG. 1,

FIG. 3 is a partially transparent view of the assembly of FIG. 1,

FIG. 4 is a profile cross-section view of the flag of the assembly of FIG. 1,

FIG. 5 diagrammatically shows a second embodiment of an assembly comprising a flag according to the invention,

FIG. 6 is a partially transparent view of the assembly of FIG. 5,

FIG. 7 diagrammatically shows a third embodiment of an assembly comprising a flag according to the invention.

Note that the figures disclose the invention in a detailed manner in order to implement the invention, said figures can of course be used to better define the invention where applicable.

### DETAILED DESCRIPTION

In the following description, the invention will be described in its application for an advertising flag, without this limiting the scope of the present invention. Indeed, the flag according to the invention could also be devoid of advertising mentions and, for example, be used as a lighted or lighting decoration.

The flag according to the invention is configured to be mounted on a support structure preferably comprising a mast. The term “mast” also means a pole, a shaft, a flagpole or a rod. Note however that the flag according to the invention could be fixed by any other suitable means such as, for example, a cord, wire, a system of screws, rivets, hooks and eyecups, etc.

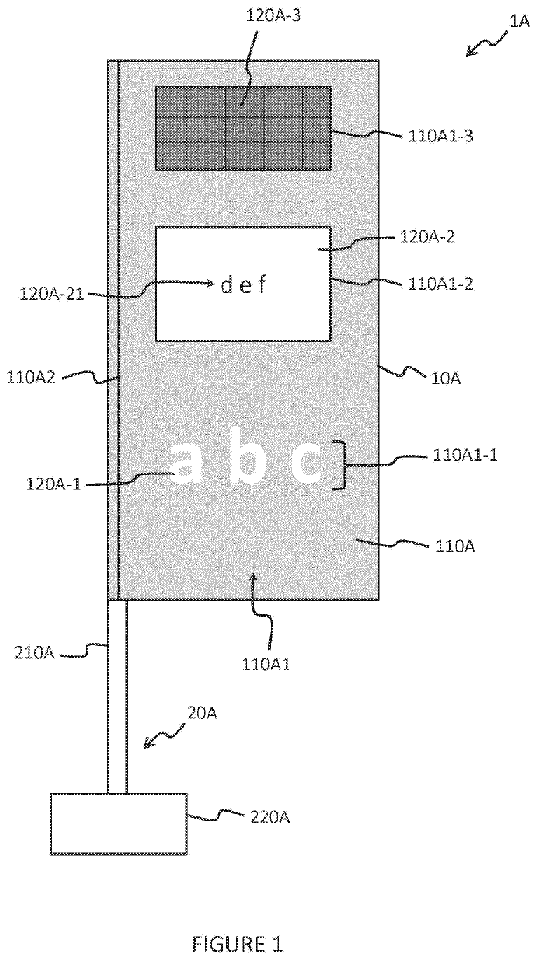

FIG. 1 shows a first embodiment of an assembly 1A comprising a flag 10A according to the invention mounted on a support structure 20A. In this non-limiting example, the support structure 20A comprises a vertical mast 210A (i.e. extending according to the land vertical) on which the flag 10A is fixed which has the shape of a pennant.

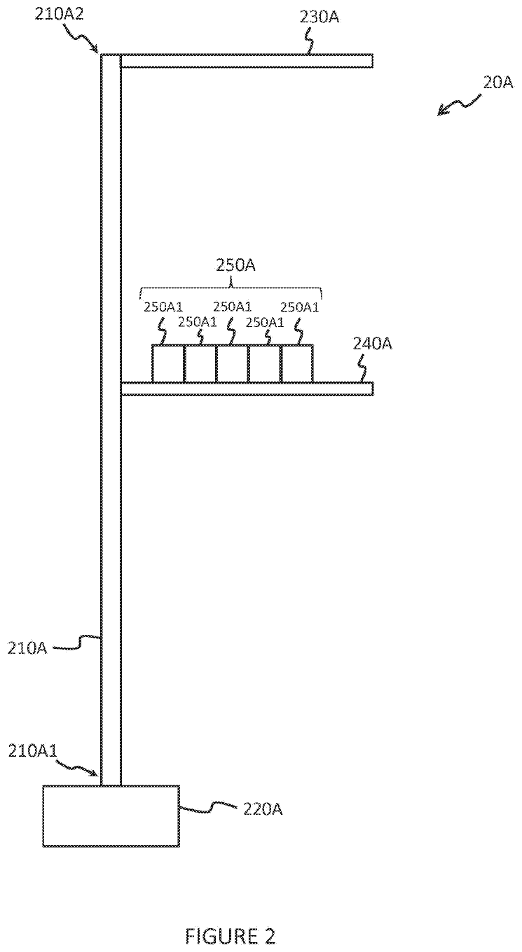

In reference to FIG. 2, the mast 210A comprises a proximal end 210A1 mounted on a support leg 220A and a distal end 210A2. The support structure 20A further comprises a first support bar 230A and a second support bar 240A, both extending perpendicularly from the mast 210A in the same vertical plane.

The first support bar 230A extends from the distal end 210A1 of the mast 210A so as to support the weight of flag 10A. The second support bar 240A extends substantially from the middle of the mast 210A and supports an electrical energy storage battery 250A. In this non-limiting example, the battery 250A comprises several electrical energy storage modules 250A1 connected in series so as to adapt to the width of the flag 10A. Alternatively, note that the battery 250A could comprise a single electrical energy storage module.

In reference to FIGS. 1, 3 and 4, the flag 10A comprises a piece of material 110A comprising two thicknesses defining two opposite faces 110A1. The piece of material 110A is mounted on the mast 210A, bearing against the first support bar 230A which partially supports the weight thereof. Preferably, the flag 10A is substantially flat and of low thickness “e”, for example less than 5 cm thick e (FIG. 4), preferable less than 3 cm thick e.

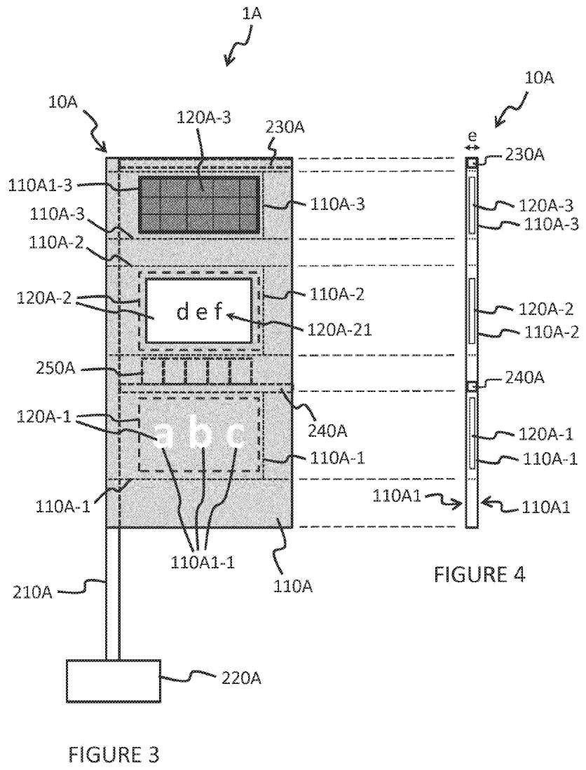

In this example, in reference to FIG. 3, the piece of material 110A comprises a first pocket 110A-1, formed between the two thicknesses of the faces 110A1, wherein a first lighted panel 120A-1 of rectangular shape is inserted. Each face 110A1 of the piece of material 110A comprises a series of openings 110A1-1 located on said first pocket 110A-1 in such a way as to allow the passage of the light emitted by said first lighted panel 120A-1 through said series of openings 110A1-1. In this example, the series of openings 110A1-1 represents letters “a b c”, defining for example a name to be promoted. Thus, the light emitted by the first lighted panel 120A-1 is filtered by the series of openings 110A1-1 located in line with the first pocket 110A-1, on the two faces 110A1 of the flag 10A in such a way that the letters appear illuminated. Note however that any form of opening is possible. The first lighted panel 120A-1 is connected to the battery 250A so as to be electrically powered. In this example, the first lighted panel 120A-1 is a lighting panel, for example with LED or any other suitable technology.

The piece of material 110A comprises a second pocket 110A-2 formed between the two thicknesses of the faces 110A1, wherein a second lighted panel 120A-2 of rectangular shape is inserted. Each face 110A1 of the piece of material 110A comprises an opening 110A1-2 of rectangular shape located on said second pocket 110A-2 in such a way as to allow the passage of the light emitted by said second lighted panel 120A-2. In this example, the second lighted panel 120A-2 comprises inscriptions 120A-21 on these two faces, in this example letters “e f g” affixed by screen printing (which could also for example be a logo affixed by screen printing). The second lighted panel 120A-2 is connected to the battery 250A so as to be electrically powered. In this example, the second lighted panel 120A-2 is a lighting panel, for example with LED or any other suitable technology.

Still in this example, the piece of material 110A comprises a third pocket 110A-3 formed between the two thicknesses of the faces 110A1, wherein a solar panel 120A-3, of rectangular shape, is inserted, which is electrically connected to the battery 250A. One of the faces 110A1 of the piece of material 110A comprises an opening 110A1-3 of rectangular shape located on said third pocket 110A-3 in such a way as to allow the passage of the light towards said solar panel 120A-3. The solar panel 120A-3 makes it possible to transform the light energy, radiated in particular by the sun, into electrical energy making it possible in particular to recharge the battery 250A. Preferably, the thickness of the solar panel 120A-3 is less than 3 cm.

The piece of material 110A is threaded onto the mast 210A and fixed around said mast 210A using a self-gripping strip 110A2, for example of the Velcro® type, disposed over the entire height of the flag 10A, along the mast 210A. The first pocket 110A-1, the second pocket 110A-2, the third pocket 110A-3 and the battery 250 are thus easily accessible by detaching the self-gripping strip 110A2 and by separating the two thicknesses of the piece of material 110A, for example for replacing the first lighted panel 120A-1, the second lighted panel 120A-2, the solar panel 120A-3 or the battery 250.

Alternatively, note that the flag 10A could comprise an electric cable connected on the one hand to the first lighted panel 120A-1 and to the second lighted panel 120A-2 and on the other hand to an electrical outlet (not shown) making it possible to connect said electric cable to an external electrical network, for example via a transformer, so as to power the first lighted panel 120A-1 and to the second lighted panel 120A-2. In this case, the flag 10A may be devoid of a solar panel. When the flag 10A comprises a solar panel 120A-3, said solar panel 120A-3 may be connected via an electrical outlet and an electric cable to an external electrical network or to an external piece of electrical equipment so as to provide it with electrical energy.

Note in addition that the flag 10A could comprise, alternatively or as a supplement of a lighting panel 120A-1, 120A-2, a lighted panel of the display panel type. Such a display panel may, for example, be of the LCD, OLED®, QLED® type or any other suitable technology. Advantageously, such a display panel may be connected to a communication network so as to control the display remotely, for example from a smartphone, a tablet or a computer.

Note finally that alternatively, the support structure 20A could be devoid of a second support bar 240A and the battery 250A could be inserted into a specific pocket formed between the thicknesses of the faces 110A1 of the piece of material 110A.

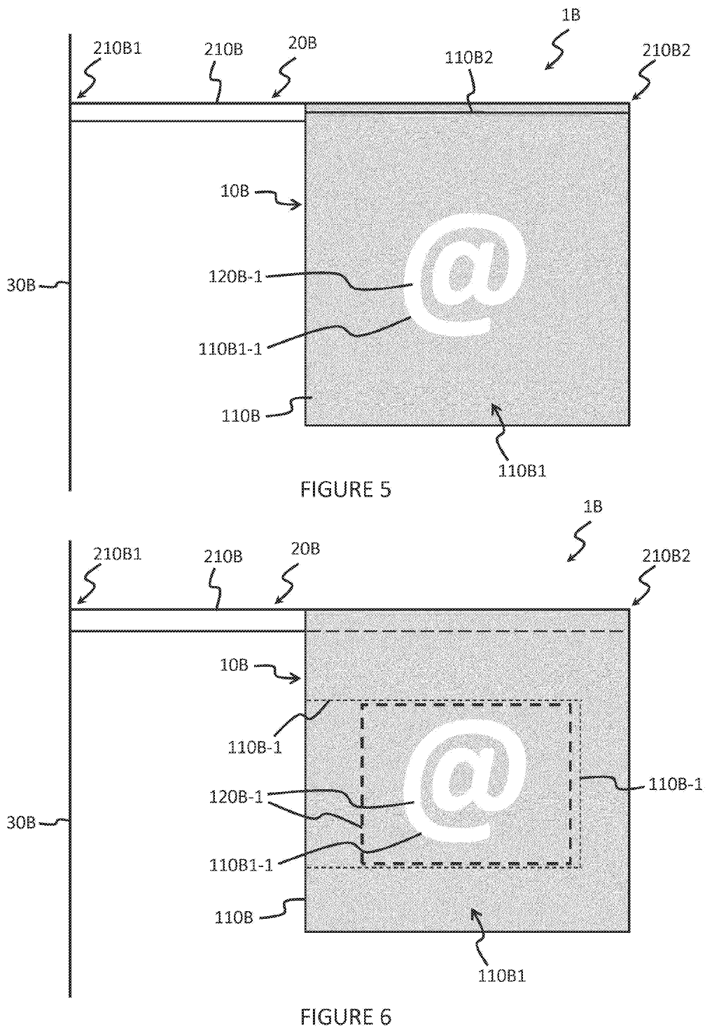

FIGS. 5 and 6 show a second embodiment of an assembly comprising a flag 10B according to the invention and a support structure 20B. In this non-limiting example, the support structure 20B has the shape of a horizontal mast 210B (i.e. extending according to the land horizontal) to which is attached the flag 10B which is then called a “wall” flag.

In this example, the mast 210B comprises a proximal end 210B1 fixed on a vertical wall 30B and a distal end 210B2. The mast 210B preferably has the shape of a bar, for example made of metal, or a rod that makes it possible to support the weight of flag 10B.

The flag 10B comprises a piece of material 110B comprising two thicknesses defining two opposite faces 110B1. Preferably, the flag 110B is substantially flat and of low thickness, for example less than 5 cm thick, preferably less than 3 cm thick.

In this non-limiting example, in reference to FIG. 6, the piece of material 110B comprises a single pocket 110B-1, formed between the two thicknesses of the faces 110B1, wherein a lighting panel 120B-1 is inserted, for example with LED or any other suitable technology. Each face of the piece of material 110B comprises a series of openings 110B1-1 located on said pocket 110B-1 in such a way as to allow the passage of the light emitted by said lighting panel 120B-1 through said series of openings 110B1-1.

In this example, the series of openings 110B1-1 represents a character “@”, defining for example a name to be promoted. Thus, the light emitted by the lighting panel 120B-1 is filtered by the series of openings 110B1-1 located in line with the pocket 110B-1, on the two faces 110B1 of the flag 10B in such a way that the character appears illuminated. Note however that any other form of opening is possible.

In this example, the flag 10B being a wall flag and fixed, the lighting panel 120B-1 is advantageously connected via a power supply cable to an electrical network (not shown) making it possible to power it electrically, which avoids having to use a rechargeable power supply battery built into the flag 10B.

The piece of material 110B is threaded onto the mast 210B and fixed using a self-gripping strip 110B2, for example of the Velcro® type, disposed over the entire length of the flag 10B, along the mast 210B.

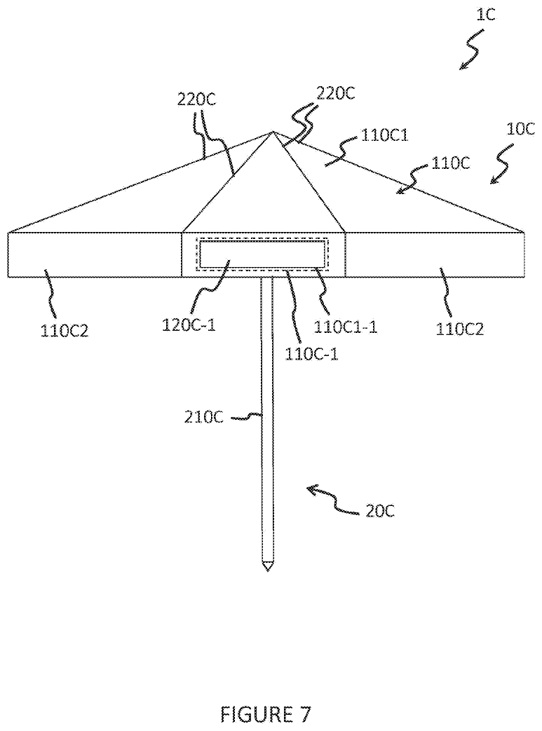

FIG. 7 shows a third embodiment of the assembly 1C according to the invention wherein the flag 10C is a sunshade canvas 110C mounted on a support structure 20C. The sunshade canvas 110C comprises a central portion 110C1, forming an umbrella, and a peripheral portion 110C2 that constitutes a free edge extending from the central portion 110C1. The support structure 20C comprises a mast 210C and ribs 220C mounted on said mast 210C making it possible to support the central portion 110C1 of the sunshade canvas 110C, the peripheral portion 110C2 extending from the free end of the ribs 220C. The peripheral portion 110C2 comprises a pocket 110C-1, wherein a lighted panel 120C-1 is inserted, and a rectangular opening 110C1-1 that allows for the passage of the light emitted by the lighted panel 120C-1.

The present invention is not limited to solely the embodiments described in the present document. Note in particular that the shapes and the dimensions of the elements of the flag or of the assembly could be different without this being a limitation to the scope of the present invention.

1-10. (canceled)

11. A flag comprising a piece of material suitable for mounting on a mast and comprising at least two faces, said flag wherein:
said piece of material comprises at least one pocket, formed between said two faces and is suitable for receiving an electrical or electronic device; and
at least one of the faces of the piece of material comprises at least one opening located on said at least one pocket.

12. The flag according to claim 11, comprising at least one electrical or electronic device inserted into the at least one pocket.

13. The flag according to claim 12, wherein the device is a lighted panel.

14. The flag according to claim 13, wherein the lighted panel is a lighting panel or a display panel.

15. The flag according to claim 11, wherein the piece of material comprises two faces opposite one another.

16. The flag according to claim 11, wherein the at least one opening delimits at least one letter or at least one logo.

17. The flag according to claim 11, wherein the at least one opening is of rectangular or square shape.

18. The flag according to claim 12, wherein the device is a solar panel.

19. An assembly comprising a support structure and the flag, according to claim 11, mounted on said support structure.

20. The assembly according to claim 19, further comprising at least one electrical energy storage battery.
